(19) United States
(12) Patent Application Publication
(10) Pub. No.: US 2014/0233572 A1
(43) Pub. Date: Aug. 21, 2014

(54) Handling Method and Device for Cell Concatenation

(71) Applicant: HUAWEI TECHNOLOGIES CO., LTD., Shenzhen (CN)

(72) Inventors: Shengjin Xiao, Beijing (CN); Wei Li, Budapest (HU); Tianhui Zeng, Beijing (CN)

(73) Assignee: HUAWEI TECHNOLOGIES CO., LTD., Shenzhen (CN)

(21) Appl. No.: 14/264,852

(22) Filed: Apr. 29, 2014

Related U.S. Application Data
(63) Continuation of application No. PCT/CN2012/079548, filed on Aug. 2, 2012.

(30) Foreign Application Priority Data
Feb. 24, 2012 (CN) 201210044035.6

(51) Int. Cl. H04L 12/723

(52) U.S. Cl. CPC H04L 45/505
USPC 370/393

(57) ABSTRACT

A handling method for cell concatenation, includes receiving a cell of a packet before a concatenation timeout period expires and before the total number of received cells of the packet reaches a concatenation number. The method further includes determining whether an end-of-packet cell of the packet is received. If the end-of-packet cell of the packet is received, the received cell of the packet is encapsulated into a first PWE3 packet. The first PWE3 packet is sent to an MPLS network. The present application relieves a limit of the concatenation number or the concatenation timeout period in a cell concatenation process of the packet so as to reduce a delay and a jitter of the packet caused by the cell concatenation.

This application is a continuation of International Application No. PCT/CN2012/079548, filed on Aug. 2, 2012, which claims priority to Chinese Patent Application No. 201210044035.6, filed on Feb. 24, 2012, both of which are hereby incorporated by reference in their entireties.

### TECHNICAL FIELD

The present application relates to communications technologies, and in particular, to a handling method and device for cell concatenation.

### BACKGROUND

In an Asynchronous Transfer Mode (ATM) network, an ATM cell is transferred transparently by connecting conventional ATM network resources using Pseudo-Wire Emulation Edge to Edge (PWE3), and then emulating a conventional ATM service on a Multi-Protocol Label Switching (MPLS) network, so that an end user perceives no difference. However, if each cell is encapsulated into a PWE3 packet, a problem of low bandwidth utilization rate for ATM is caused.

In order to solve the above technical problem, the prior art improves the bandwidth utilization rate for ATM on an MPLS network by cell concatenation. Specifically, an input cell is queued, before a concatenation timeout period expires, to make a PWE3 packet until the concatenation timeout period expires or a predefined concatenation number is reached, and then is sent to the MPLS network.

However, when more cells are to be concatenated, because each cell to be concatenated must wait until all cells to be concatenated are received, or until the concatenation timeout period expires, the existing handling method for cell concatenation may cause problems of delay and jitter.

### SUMMARY OF THE INVENTION

The present application provides a handling method and device for cell concatenation to solve the problems of additional delay and jitter caused by the handling method for cell concatenation in the prior art.

In a first aspect, the present application provides a handling method for cell concatenation, including receiving a cell of a packet, and determining whether an end-of-packet cell of the packet is received before a concatenation timeout period expires and before the number of received cells of the packet reaches a concatenation number. If the end-of-packet cell of the packet is received, encapsulating the received cell of the packet into a first Pseudo Wire Edge-to-Edge PWE3 packet, and sending the first PWE3 packet to a Multi-Protocol Label Switching MPLS network.

In another aspect, the present application provides a handling device for cell concatenation, including a receiving module, a concatenation handling module, an encapsulating module, and a sending module. The receiving module is configured to receive a cell of a packet. The concatenation handling module is configured to determine whether an end-of-packet cell of the packet is received before a concatenation timeout period expires and before the number of received cells of the packet reaches a concatenation number. The encapsulating module is configured to encapsulate the received cell of the packet into a first Pseudo-Wire Emulation Edge-to-Edge PWE3 packet if the concatenation handling module determines that the end-of-packet cell of the packet is received. The sending module is configured to send the first PWE3 packet to a Multi-Protocol Label Switching MPLS network.

The benefit of the present application lies in that before a concatenation timeout period expires and before the number of received cells of a packet reaches a concatenation number, if an end-of-packet cell of the packet is received, the received cell of the packet is encapsulated into a first PWE3 packet. This relieves a limit of the concatenation number or the concatenation timeout period in a forwarding process for cell concatenation of the packet, so as to reduce a delay and a jitter for the packet caused by cell concatenation.

### BRIEF DESCRIPTION OF THE DRAWINGS

FIG. 1 is a flowchart of a handling method for cell concatenation according to an embodiment of the present application;

FIG. 2 is a flowchart of a handling method for cell concatenation according to another embodiment of the present application;

FIG. 3a is a flowchart of a handling method for cell concatenation according to still another embodiment of the present application;

FIG. 3b is a flowchart of a handling method for cell concatenation according to still another embodiment of the present application;

FIG. 4 is a schematic structural diagram of a handling device for cell concatenation according to an embodiment of the present application; and

FIG. 5 is a schematic structural diagram of a handling device for cell concatenation according to another embodiment of the present application.

### DETAILED DESCRIPTION OF ILLUSTRATIVE EMBODIMENTS

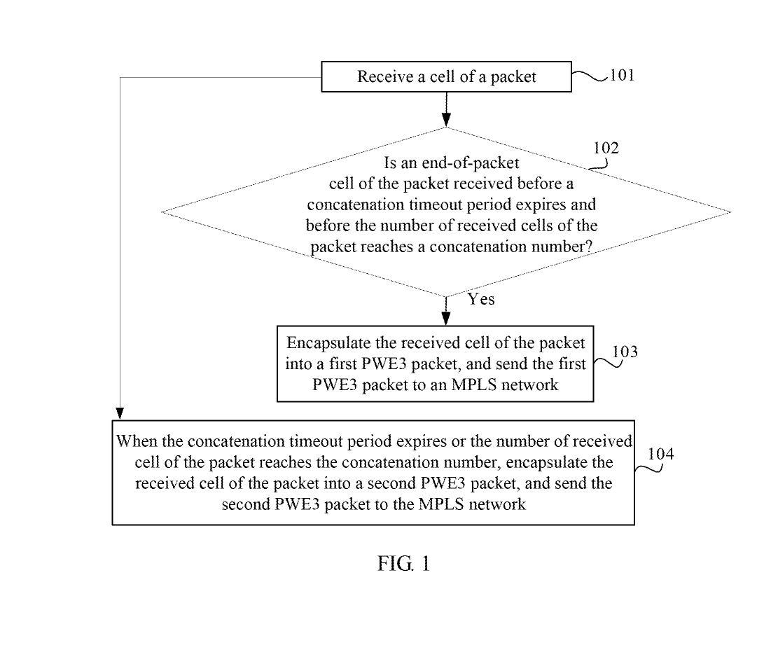

FIG. 1 is a flowchart of a handling method for cell concatenation according to an embodiment of the present application. As shown in FIG. 1, the method according to this embodiment includes the following steps described below.

101. Receive a cell of a packet.

102. Determine whether an end-of-packet cell of the packet is received before a concatenation timeout period expires and before the number of received cells of the packet reaches a concatenation number.

103. If the end-of-packet cell of the packet is received, encapsulate the received cell of the packet into a first PWE3 packet, and send the first PWE3 packet to an MPLS network.

In this embodiment, if the end-of-packet cell of the packet is received before the concatenation timeout period expires and before the number of received cells of the packet reaches the concatenation number, the received cell of the packet is encapsulated into the first PWE3 packet. This relieves a limit of the concatenation number and the concatenation timeout period in a cell concatenation process of the packet, so as to reduce a delay and a jitter caused by the cell concatenation.

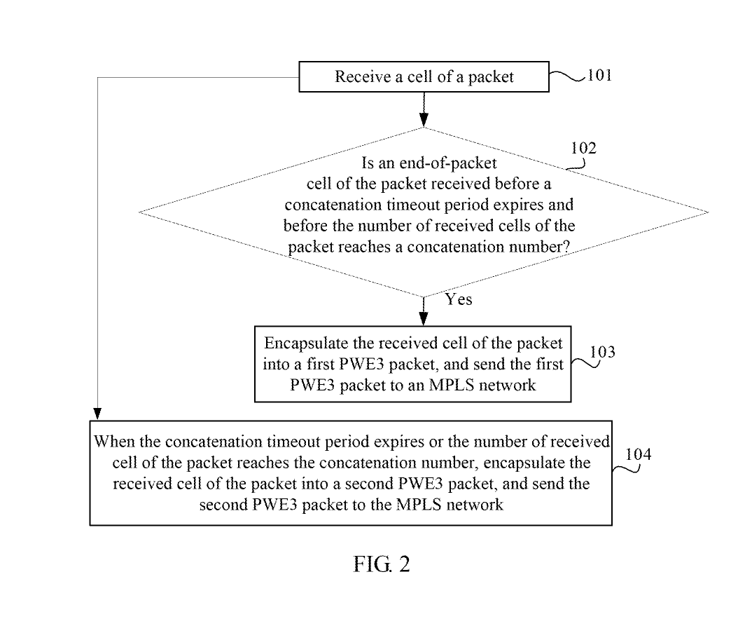

Alternatively, on the basis of the embodiment illustrated in FIG. 1, FIG. 2 is a flowchart of a handling method for cell concatenation according to another embodiment of the present application. As shown in FIG. 2, after 101, the method may further include the following steps described below.

104. When the concatenation timeout period expires or the number of received cells of the packet reaches the concatenation number, the received cell of the packet is encapsulated into a second PWE3 packet. The second PWE3 packet is sent to the MPLS network.

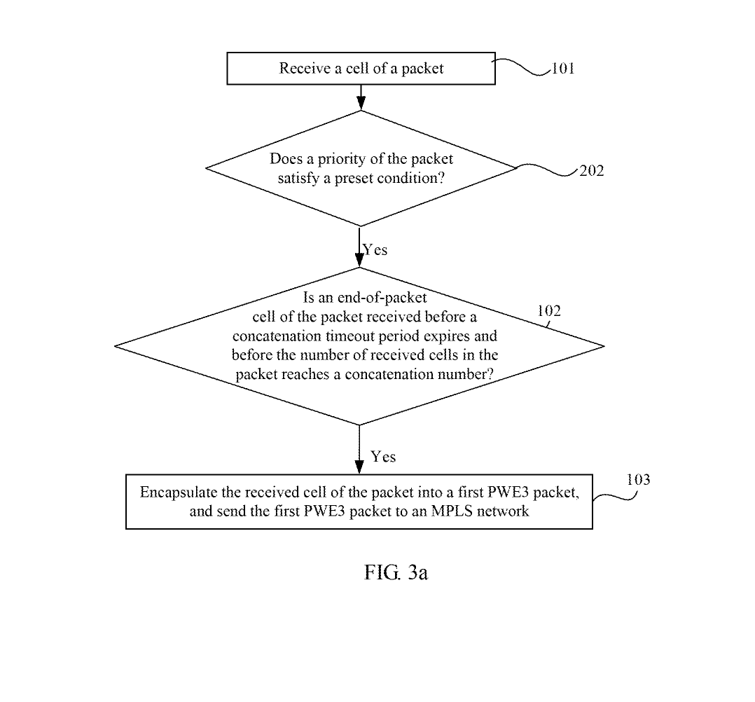

Alternatively, on the basis of the embodiment illustrated in FIG. 1 or FIG. 2, FIG. 3a is a flowchart of a handling method for cell concatenation according to still another embodiment of the present application. As shown in FIG. 3a, after 101, the method according to the embodiment includes the following steps described below.

202. Determine a priority of the packet. If the priority of the packet satisfies a preset condition, perform step 102, which determines whether an end-of-packet cell of the packet is received before a concatenation timeout period expires and before the number of received cells of the packet reaches a concatenation number.

Alternatively, the satisfying, by the priority of the packet, the preset condition may indicate that: the packet is a real-timeness sensitive packet, or the packet is a packet on which no delay processing is performed.

For example, a User Datagram Protocol (UDP) port carried in a head cell of the packet may be based on to determine whether the packet is a voice packet; if the packet is a voice packet, the packet is real-timeness sensitive, and therefore the priority of the packet satisfies the preset condition.

For another example, it may be determined whether a cell loss priority (CLP) value of a head cell of the packet is equal to a preset CLP value (for example, the preset CLP value is 0); and if yes, it indicates that no delay processing is performed on the packet before, and therefore the priority of the packet satisfies the preset condition.

Alternatively, FIG. 3b is a flowchart of a handling method for cell concatenation according to still another embodiment of the present application. As shown in FIG. 3b, if the priority of the packet does not satisfy the preset condition, step 104 is performed.

In this embodiment, concatenation is performed differently on packets having different priorities respectively, where a packet having a priority satisfying the preset condition is relieved from the limit of the concatenation number and the concatenation timeout period, which reduces a delay and a jitter caused by the cell concatenation, and improves network transmission quality and network bandwidth utilization.

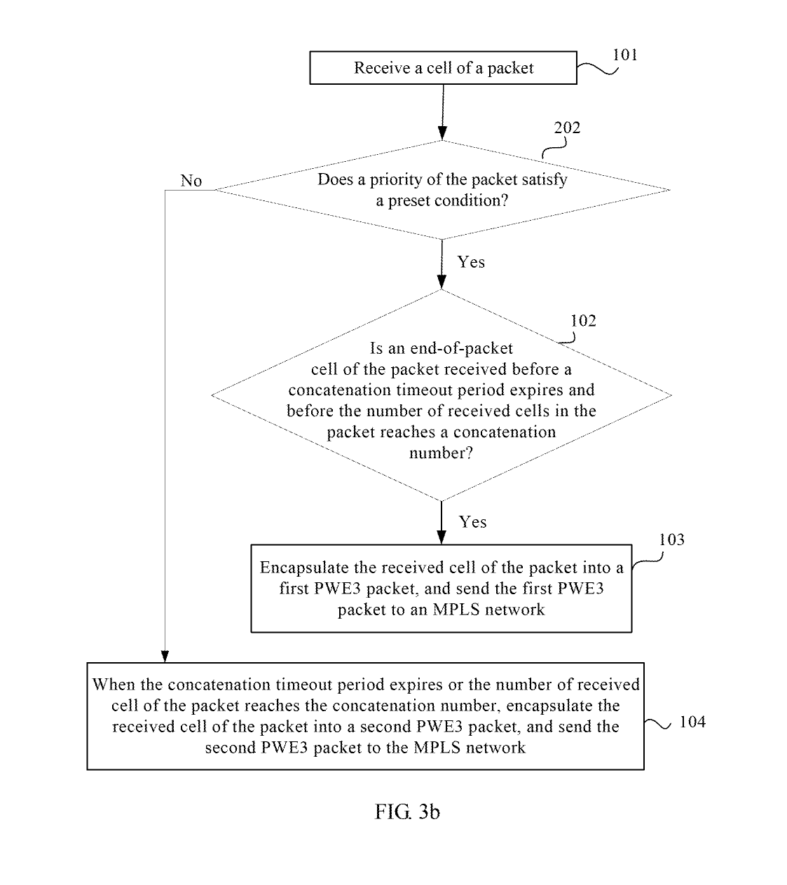

FIG. 4 is a schematic structural diagram of a handling device for cell concatenation according to an embodiment of the present application. As shown in FIG. 4, the handling device for cell concatenation according to this embodiment includes a receiving module 11, a concatenation handling module 12, an encapsulating module 13, and a sending module 14. The receiving module 11 is configured to receive a cell of a packet. The concatenation handling module 12 is configured to determine whether an end-of-packet cell of the packet is received before a concatenation timeout period expires and before the number of received cells of the packet reaches a concatenation number. The encapsulating module 13 is configured to encapsulate the received cell of the packet into a first PWE3 packet if the concatenation handling module 12 determines that the end-of-packet cell of the packet is received. The sending module 14 is configured to send the first PWE3 packet to an MPLS network.

The handling device for cell concatenation according to the embodiment may implement the technical solution according to the method embodiment illustrated in FIG. 1, where the implementation principle thereof is similar and is not described repeatedly herein.

In this embodiment, if the end-of-packet cell is received before the concatenation timeout period expires and before the number of received cells of the packet reaches the concatenation number, the received cell of the packet is encapsulated into the first PWE3 packet. This relieves a limit of the concatenation number or the concatenation timeout period in a cell concatenation process of the packet, so as to reduce a delay and a jitter caused by the cell concatenation.

Further, in another embodiment of the present application, on the basis of the embodiment illustrated in FIG. 4, when the concatenation timeout period expires or the number of received cells of the packet reaches the concatenation number, the encapsulating module 13 is further configured to encapsulate the received cell of the packet into a second PWE3 packet; and the sending module 14 is further configured to send the second PWE3 packet to the MPLS network.

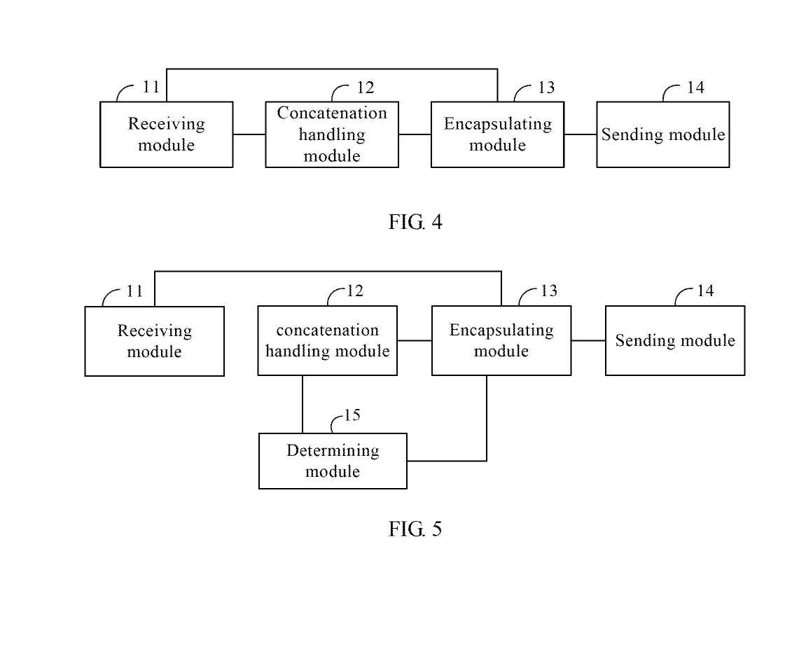

FIG. 5 is a schematic structural diagram of a handling device for cell concatenation according to another embodiment of the present application. As shown in FIG. 5, on the basis of the embodiment illustrated in FIG. 4, the device further includes a determining module 15, configured to determine a priority of the packet. If the determining module 15 determines that the priority of the packet satisfies a preset condition, before the concatenation timeout period expires and before the number of received cells of the packet reaches the concatenation number, the concatenation handling module 12 is triggered.

If the determining module 15 determines that the priority of the packet does not satisfy the preset condition, the encapsulating module 13 is triggered when the concatenation timeout period expires or the number of received cells of the packet reaches the concatenation number.

The device described in this embodiment of the present application may implement the method described in the embodiment of the present application, where the implementation principle thereof is similar and is not described repeatedly herein.

In this embodiment, when the end-of-packet cell of the packet is received before the concatenation timeout period expires and before the number of cells of the packet reaches the concatenation number, each received cell of the packet is encapsulated into the first PWE3 packet, and then the first PWE3 packet is sent to the MPLS network, so that the packet is relieved from the limit of the concatenation number or the concatenation timeout period in the forwarding process for the cell concatenation of the packet, so as to reduce a delay and a jitter for the packet caused by the cell concatenation.

A person of ordinary skill in the art may understand that all or a part of the steps of the foregoing method embodiments may be implemented by a program instructing relevant hardware. The foregoing program may be stored in a computer readable storage medium. When the program runs, the steps of the foregoing method embodiments are performed. The foregoing storage mediums include various mediums capable of storing program code, such as an ROM, an RAM, a magnetic disk, or an optical disc.

Finally, it should be noted that the foregoing embodiments are merely intended for describing the technical solutions of the present application other than limiting the present application. Although the present application is described in detail with reference to the foregoing embodiments, a person of ordinary skill in the art should understand that he may still make modifications to the technical solutions described in the foregoing embodiments, or make equivalent replacements to some or all the technical features thereof, without departing from the spirit and scope of the technical solutions of the embodiments of the present application.

What is claimed is:

1. A handling method for cell concatenation comprising:
receiving a cell of a packet;
determining whether an end-of-packet cell of the packet is received before a concatenation timeout period expires and before a total number of received cells of the packet reaches a concatenation number; and
if the end-of-packet cell of the packet is received, encapsulating the received cell of the packet into a first Pseudo Wire Edge-to-Edge (PWE3) packet, and sending the first PWE3 packet to a Multi-Protocol Label Switching (MPLS) network.

2. The handling method for cell concatenation according to claim 1, further comprising: when the concatenation timeout period expires or the total number of received cells of the packet reaches the concatenation number, encapsulating the received cell of the packet into a second PWE3 packet, and sending the second PWE3 packet to the MPLS network.

3. The handling method for cell concatenation according to claim 2, after the receiving the packet, further comprising:
determining a priority of the packet, and
wherein the determining whether the end-of-packet cell is received before the concatenation timeout period expires and before the total number of received cells of the packet reaches the concatenation number, comprises:
if the priority of the packet satisfies a preset condition, determining that the end-of-packet cell of the packet is received before the concatenation timeout period expires and before the total number of received cells of the packet reaches the concatenation number.

4. The handling method for cell concatenation according to claim 3, wherein the encapsulating, when the concatenation timeout period expires or the total number of received cells of the packet reaches the concatenation number, the received cell of the packet into the second PWE3 packet, and sending the second PWE3 packet to the MPLS network comprises:
if the priority of the packet does not satisfy the preset condition, encapsulating the received cell of the packet into the second PWE3 packet, and sending the second PWE3 packet to the MPLS network when the concatenation timeout period expires or the total number of received cells of the packet reaches the concatenation number.

5. The handling method for cell concatenation according to claim 3, wherein the priority of the packet satisfying the preset condition comprises the packet is a real-timeness sensitive packet.

6. The handling method for cell concatenation according to claim 3, wherein the priority of the packet satisfying the preset condition comprises a packet on which no delay processing is performed.

7. A handling device for cell concatenation, comprising:
a receiving module configured to receive a cell of a packet;
a concatenation handling module configured to determine whether an end-of-packet cell of the packet is received before a concatenation timeout period expires and before a total number of received cells of the packet reaches a concatenation number;
an encapsulating module configured to encapsulate the received cell of the packet into a first Pseudo-Wire Emulation Edge-to-Edge (PWE3) packet if the concatenation handling module determines that the end-of-packet cell of the packet is received; and
a sending module configured to send the first PWE3 packet to a Multi-Protocol Label Switching (MPLS) network.

8. The handling device for cell concatenation according to claim 7, wherein when the concatenation timeout period expires or the total number of received cells of the packet reaches the concatenation number.

9. The handling device for cell concatenation according to claim 8, wherein the encapsulating module is further configured to encapsulate the received cell of the packet into a second PWE3 packet.

10. The handling device for cell concatenation according to claim 9, wherein the sending module is further configured to send the second PWE3 packet to the MPLS network.

11. The handling device for cell concatenation according to claim 8, further comprising a determining module configured to determine a priority of the packet, wherein if the determining module determines that the priority of the packet satisfies a preset condition, before the concatenation timeout period expires and before the total number of received cells of the packet reaches the concatenation number, the concatenation handling module is triggered.

12. The handling device for cell concatenation according to claim 11, wherein if the determining module determines that the priority of the packet does not satisfy the preset condition, when the concatenation timeout period expires or the total number of received cells of the packet reaches the concatenation number, the encapsulating module is triggered.
